(19) United States
(12) Patent Application Publication
(10) Pub. No.: US 2007/0234555 A1
(43) Pub. Date: Oct. 11, 2007

(54) Rotor assembly fixture for magnet magnetization

(75) Inventors: Victor Obeid, Collegeville, PA (US); Andre Garon, Anjou (CA); Conrad Pelletier, Montreal (CA)

Correspondence Address: FULBRIGHT & JAWORSKI L.L.P., 600 CONGRESS AVE., SUITE 2400, AUSTIN, TX, 78701, US

(73) Assignee: Cardianove Inc., Montreal (CA)

(21) Appl. No.: 11/398,999

(22) Filed: Apr. 6, 2006

(51) Int. Cl. H02K 15/00

(52) U.S. Cl. 29/732; 29/596; 29/735

(57) ABSTRACT

A fixture used for supporting and protecting a rotor during the magnetization process comprising features enabling it to properly support and protect a delicate rotor is described herein. Generally, the fixture is prevented from rolling on a horizontal surface, may seal the delicate rotor assembly therein, maintains the rotor assembly by its opposed longitudinal ends and/or allows the magnetization process results to be tested while the rotor remains sealed inside.

### FIELD OF THE INVENTION

The present invention generally relates to fixtures. More specifically, the present invention is concerned with a rotor assembly fixture to be used during the magnetization of the magnet of a rotor assembly.

### BACKGROUND OF THE INVENTION

Rotors are used in numerous fields and, with the rise of miniaturization, rotors find themselves employed even in more applications. For instance, in the medical field, small cardiac pumps which can be inserted inside a heart's ventricle, are now designed with small rotors. For the making of such delicate rotors, special attention and equipments have to be considered.

For instance, since the shape of small rotors is often critical, the rotors are first machined before being magnetized. Because of their small size, such machined rotors tend to be very fragile and delicate to handle during the magnetization process. Some of the encountered challenges include:
1) keeping the integrity of the surfaces of the rotor assembly during the magnetization process;
2) providing solid and sound support for the rotor assembly in order to avoid any deformation, movement and unstability;
3) providing means for measurements, control and monitoring while or shortly after the rotor assembly is being magnetized;
4) providing sealing means in order to isolate the rotor assembly from any foreign particles during and after the magnetization process; and
5) protecting the rotor assembly during transportation.

It would be therefore very interesting to have an equipment made for such a specific application of rotors, which can meet all the needs mentioned above.

### OBJECTS OF THE INVENTION

An object of the present invention is therefore to provide a rotor assembly fixture for magnet magnetization.

### SUMMARY OF THE INVENTION

More specifically, in accordance with the present invention, there is provided a fixture for supporting a rotor assembly during magnetization, the fixture comprising: a body defining a chamber and comprising first and second ends and at least one flat external surface, the first end defining an opening; and a cover so mountable to the body as to selectively close the opening; wherein the chamber receives the rotor assembly and the flat external surface enables the fixture to rest on a generally horizontal surface in a substantially stable manner.

In accordance with another aspect of the present invention, there is provided a fixture for supporting a rotor assembly during magnetization, the fixture comprising: a body defining a chamber and comprising first and second ends and at least one cut-out therein, the first end defining an opening to the chamber; and a cover so mountable to the body as to selectively close the opening; wherein the cut-out provides for a gauss meter to measure the magnetic strength of the magnetized rotor while the rotor assembly stays inside the chamber.

In accordance with a further aspect of the present invention, there is provided a fixture for supporting a rotor assembly during magnetization, the rotor assembly being provided with longitudinally opposed ends, the fixture comprising: a body defining a chamber and a longitudinal axis and comprising first and second ends, the first end defining an opening, the second end being closed and comprising a first rotor end supporting element; and a cover so mountable to the body as to selectively close the opening and comprising a second rotor end supporting element; wherein the first and second rotor end supporting elements provide support for opposed ends of the rotor assembly resting inside the chamber and allow the rotor assembly to rotate about the longitudinal axis.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a fixture for supporting a rotor assembly during magnetization of the magnet of the rotor assembly, according to an embodiment of the present invention;

FIG. 2 is a sectional exploded side elevation view showing a rotor assembly fitting into the fixture of FIG. 1;

FIG. 3 is a sectional side elevation view of the fixture of FIG. 1 with its cover not mounted; and

FIG. 4 is a sectional side elevation view of the fixture of FIG. 1 with its cover mounted.

### DETAILED DESCRIPTION

Generally stated, the present invention relates to a fixture for supporting a rotor assembly during the magnetization of the rotor's magnet.

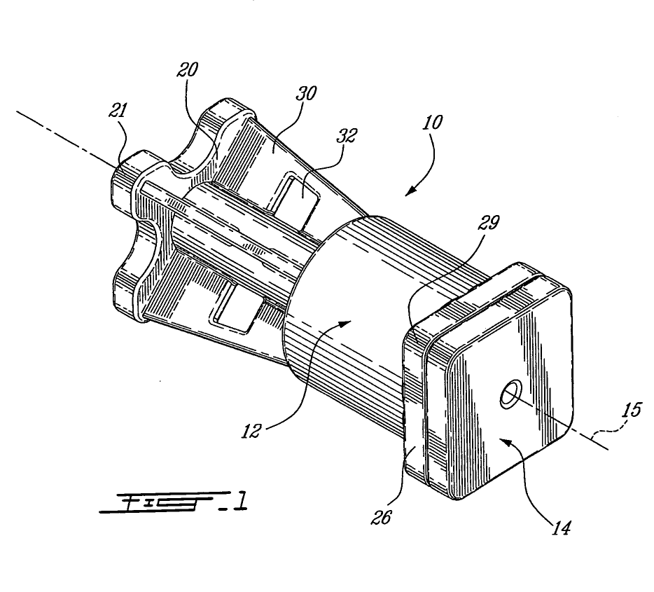

An embodiment of the present invention introduces a fixture 10 having a body 12 and a cover 14, as illustrated in FIG. 1. The fixture 10 defines a longitudinal axis 15.

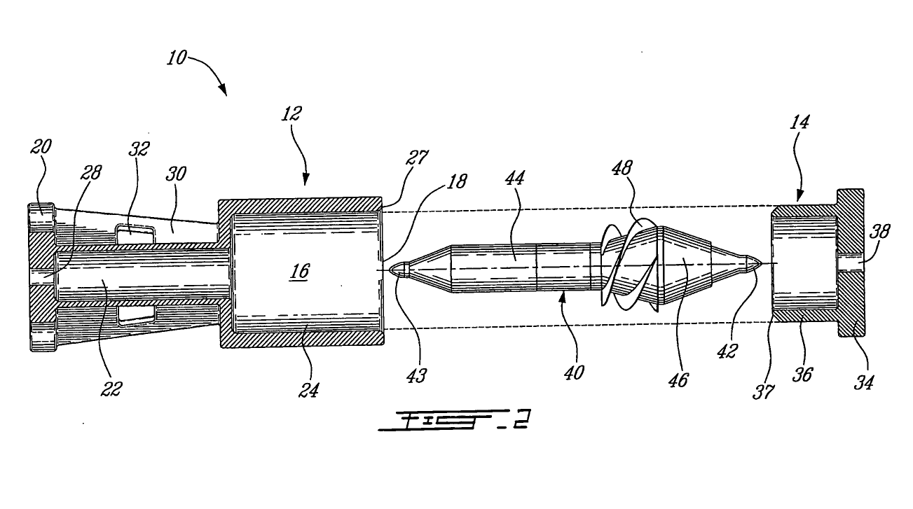

As can be better seen from FIG. 2, the body 12 defines a chamber 16 having two ends, one end defining an opening 18 and the other end defining a generally cross-shaped closed end 20. The chamber 16 is so configured and sized as to receive a rotor assembly 40 and is divided into two cylindrical sections 22 and 24 with different diameters to accommodate the particular shape of the rotor assembly 40.

More specifically, a smaller cylindrical section 22 extends from the cross-shaped closed end 20 to the larger cylindrical section 24 and is surrounded by four reinforcement plates 30. The larger cylindrical section 24 extends from the smaller cylindrical section 22 and ends with the square edges 26 (see FIG. 1) surrounding the circular opening 18. The square edges 26 have rounded inside edges 27 and rounded corners 29 (see FIG. 1). They also have a sufficient thickness to provide enough weight and flat surface for the fixture 10 to be positioned upright and to have balance.

Returning to FIG. 1, the cross-shaped closed end 20 has a flat surface, having a sufficient thickness, enabling the fixture 10 to be positioned upright (position not shown) with stability. Furthermore, together with the square edges 26, the cross-shaped end 20 allows the fixture 10 to rest horizontally on a generally horizontal surface in a stable manner and prevents the fixture 10 to roll during handling. The cross-shaped end 20 and the square edges 26 have approximately the same size. The cross-shaped end 20 has round corners 21. From the four corners of the flat surface of the cross-shaped end 20, four reinforcement plates 30 are provided to strengthen the structure of the fixture 10. Finally, the cross-shaped end 20 is provided with a recess 28 (see FIG. 2), in which one of the ends of a rotor assembly 40 can be placed.

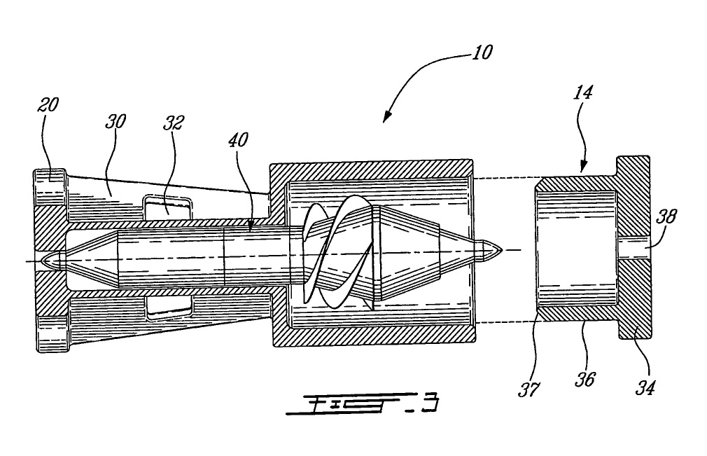

As illustrated in FIG. 1, the four reinforcement plates 30 surrounding the smaller cylindrical section 22 are trapezoidal-shaped, extending from the cross-shaped closed end 20 to the larger cylindrical section 24. They are evenly spread around and attached to the smaller cylindrical section 22. A cutout 32 is located in each plate 30, enabling a gauss meter or other types of meters (not shown) to be positioned therein to measure the magnetic strength of the magnetized rotor assembly, resting inside the chamber 16, for control or monitoring purposes without removing the rotor assembly 40 from the fixture 10. In this embodiment of the present invention illustrated in FIG. 3, the cutouts 32 are trapezoidal-shaped.

A cover 14, as better shown in FIGS. 2 and 3, comprises a flat and square portion 34, from which a cylindrically shaped shoulder 36 extends. The shoulder 36 has such a diameter and length that it snugly fits into the opening 18, thus making the fixture 10 adequately sealed. The shoulder 36 includes a beveled edge 37 facilitating the insertion of the cover 14 into the body 12. The dimensions, length and thickness of the square portion 34 are generally the same as the square edges 26 of the opening 18. Moreover, the cover 14 is provided with a recess 38 in the flat and square portion 34, the recess 38 acting as a support element for the other end of the rotor assembly 40.

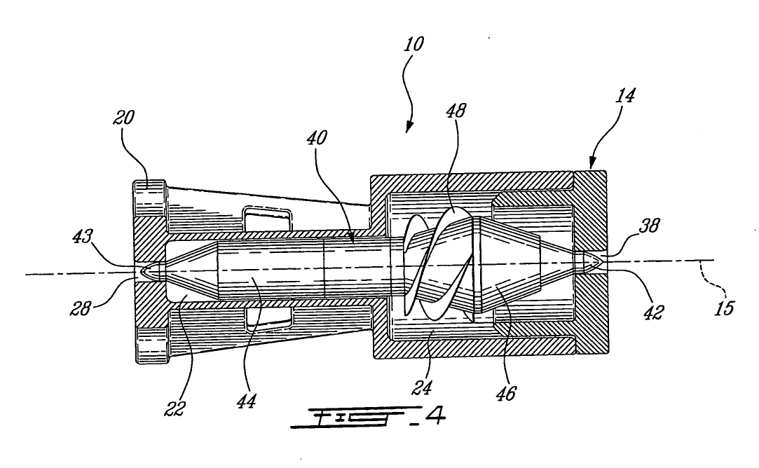

A person skilled in the art will understand that the recesses 28 and 38 provide support for the ends of a rotor assembly 40 during the magnetization process. Indeed, once the rotor assembly 40 enters the chamber 16, as illustrated in FIG. 4, its ends are placed inside the recesses 28 and 38 for stability, free rotation and pole alignment. The recesses 28 and 38 are aligned on the same longitudinal axis 15 on opposed ends of the fixture 10. It should also be understood that the thickness of the flat surface of both the cover 14 and the cross-shaped closed end 20 are so designed and sized as to provide enough depth and strength to the recesses in order for them to support the ends of the rotor assembly 40.

In order to prevent foreign particles from contaminating the rotor assembly 40, resting in the chamber 16, sealing features are provided by the fixture 10 to isolate the rotor assembly 40 from the external world during the magnetization process. As an example, the fixture 10 can be sealed by closing the cover 14 and blocking the recesses 28 and 38, as seen in FIG. 4, by the ends of the rotor assembly. It will be understood that the recesses could be designed as to be closed at all times. By doing so, not only are the rotor assembly surfaces free of scratches and uncorrupted but also they stay clean.

As illustrated in FIGS. 2 and 4, an example of a rotor assembly 40 entering the fixture 10 is given. The rotor assembly is made of titanium 6AL4V and is provided with two conical ends 42, 43 which can respectively be placed into the recess 38 of the cover 14 and the recess 28 of the cross-shaped closed end 20. The rotor assembly has two portions 44 and 46. The smaller portion 44 enters the smaller cylindrical section 22 of the chamber 16 of the fixture 10 and the larger portion 46 enters the larger cylindrical section 24 of the chamber 16. The rotor assembly is so positioned and supported by the recesses 38 and 28, that it rests comfortably and in a stable manner inside the chamber 16. The dimensions of the two cylindrical sections 22 and 24 of the chamber 16 are so designed as to adequately receive the portions 44 and 46 of the rotor assembly respectively and to enable the rotor assembly 40 to rotate freely inside the fixture 10. The larger portion 46 of the rotor assembly 40 is provided with an impeller 48.

It should be noted that such a rotor assembly 40 is only an example of rotor assemblies fitting into the fixture 10. Of course, many other rotor assemblies, properly configured and sized can use the present embodiment of the fixture 10 during their magnetization process. It is also possible to design a fixture to fit other rotor topologies not shown herein.

For instance, to magnetize a small rotor used in a cardiac pump inserted inside a heart's ventricle, the fixture 10 is provided with the following specifications and dimensions. The fixture 10 is made with a white stereo-lithographic material and has a length of 67.1 mm. Typically, the diameter of the smaller cylindrical section 22 is 8.5 mm and the diameter of the larger cylindrical section 24 is 20.5 mm. The thickness of the flat and square portion 34 of the cover 14 measures 4.6 mm. The recess 28 has a diameter of 2.8 mm and the recess 38 has a diameter of 3.2 mm. The cutouts 32 are located about 1.0 mm away from the external surface of the smaller cylindrical section 20 and in the middle of the plates 30. As an indication, each side of the flat and square portion 34 measures 25.4 mm. It should be noted that all the specifications and dimensions of the fixture 10 provided above can be changed and modified depending on the configuration and size of rotors that need to be magnetized.

Although an embodiment illustrating the present invention has been described, it should be kept in mind that many aspects can be modified without departing from the spirit of the present invention. For example, the number and the shape of the cut-outs can be different than what has been described in this document, the square and cross shapes of the cover and the closed end of the chamber can be modified, and different means, beside recesses, can be used to provide support for the rotor assembly during the magnetization process and sealing of the fixture. The dimensions and configuration of the fixture depend on the rotor assembly to be magnetized. Finally, the square portion can be replaced by other flat surfaces enabling the fixture to rest on a horizontal surface.

Although the present invention has been described in the foregoing specification by means of a non-restrictive illustrative embodiment, this illustrative embodiment can be modified at will within the scope, spirit and nature of the subject invention.

What is claimed is:

1. A fixture for supporting a rotor assembly during magnetization, said fixture comprising:
a body defining a chamber and comprising first and second ends and at least one flat external surface, said first end defining an opening; and
a cover so mountable to said body as to selectively close said opening;
wherein said chamber receives the rotor assembly and said flat external surface enables said fixture to rest on a generally horizontal surface in a substantially stable manner.

2. The fixture of claim 1, wherein said second end comprises a generally cross-shaped closed end.

3. The fixture of claim 2, wherein said opening comprises generally square edges.

4. The fixture of claim 3, wherein said generally cross-shaped closed end and said generally square edges of said opening comprise similar dimensions enabling said fixture to be supported thereby on a generally horizontal surface in a substantially stable manner.

5. The fixture of claim 1, wherein said chamber comprises two sections with one said section being larger than the other.

6. The fixture of claim 5, wherein each of said two sections are generally cylindrical-shaped.

7. The fixture of claim 1, wherein said cover is generally square-shaped.

8. The fixture of claim 7, wherein said cover comprises a recess to support a first end of the rotor assembly.

9. The fixture of claim 8, wherein said second end comprises a generally cross-shaped closed end comprising a recess to support a second end of the rotor assembly.

10. A fixture for supporting a rotor assembly during magnetization, said fixture comprising:
a body defining a chamber and comprising first and second ends and at least one cut-out therein, said first end defining an opening to said chamber; and
a cover so mountable to said body as to selectively close said opening;
wherein said cut-out provides for a gauss meter to measure the magnetic strength of the magnetized rotor while the rotor assembly stays inside the chamber.

11. The fixture of claim 10, wherein said chamber comprises a smaller cylindrical portion and a larger cylindrical portion, said smaller cylindrical portion being surrounded by four reinforcement plates radially portioned thereabout.

12. The fixture of claim 10, wherein said at least one cut-out comprises four cut-outs provided in said four reinforcement plates.

13. The fixture of claim 12, wherein said four cut-outs are generally trapezoidal-shaped.

14. The fixture of claim 10, wherein said chamber comprises at least one flat external surface enabling said fixture to rest on a generally horizontal surface in a substantially stable manner.

15. A fixture for supporting a rotor assembly during magnetization, the rotor assembly being provided with longitudinally opposed ends, said fixture comprising:
a body defining a chamber and a longitudinal axis and comprising first and second ends, said first end defining an opening, said second end being closed and comprising a first rotor end supporting element; and
a cover so mountable to said body as to selectively close said opening and comprising a second rotor end supporting element;
wherein said first and second rotor end supporting elements provide support for opposed ends of the rotor assembly resting inside said chamber and allow the rotor assembly to rotate about said longitudinal axis.

16. The fixture of claim 15, wherein said first and second supporting elements comprise recesses.

17. The fixture of claim 15, wherein said chamber comprises at least one flat external surface enabling said fixture to rest on a generally horizontal surface in a substantially stable manner.
